(19) United States
(12) Patent Application Publication
(10) Pub. No.: US 2008/0085218 A1
(43) Pub. Date: Apr. 10, 2008

(54) MOISTURE-PROOF, GAS PERMEABLE HOLDER FOR PASSIVE SAMPLERS

(75) Inventors: Gary W. SHORT, Glendale, CA (US); Philip N. SMITH, Monterey Park, CA (US)

Correspondence Address: SUGHRUE MION, PLLC, 2100 Pennsylvania Avenue, N.W., Washington, DC, 20037, US

(73) Assignee: Gary W. SHORT, Glendale, CA (US)

(21) Appl. No.: 11/870,197

(22) Filed: Oct. 10, 2007

Related U.S. Application Data
(60) Provisional application No. 60/828,905, filed on Oct. 10, 2006.

(51) Int. Cl. G01N 1/22; B32B 27/08

(52) U.S. Cl. 422/88; 96/12; 96/4

(57) ABSTRACT

A holder for retaining a passive sampler and method of monitoring a user's exposure to a gas in ambient air using a passive sampler holder are provided. The holder includes a moisture-proof housing forming at least one hole in a first surface, and a moisture-proof, gas-permeable membrane position over the at least one hole to expose at least one compartment formed in the housing to accept a passive sampler to ambient air through the moisture-proof, gas-permeable membrane.

### CROSS REFERENCE TO RELATED APPLICATIONS

This application claims priority from U.S. Provisional Application No. 60/828,905 filed on Oct. 10, 2006 in the United States Patent and Trademark Office, the disclosure of which is incorporated herein in its entirety by reference.

### BACKGROUND OF THE INVENTION

1. Field of the Invention

The present invention relates to passive samplers for gas detection, and more particularly to a moisture-resistant, gas permeable holder for chemically treated passive samplers.

2. Description of the Related Art

In many industries, gases are routinely used in the workplace. For example, ozone is an FDA approved sanitizing agent effective to kill food-borne pathogens in applications such as food processing and food processing equipment cleaning/sanitizing. The use of ozone is steadily replacing conventional sanitation techniques such as chlorine, steam or hot water.

Today, ozone is used in the processing of meat, poultry, seafood and fresh produce, and is recognized as the safest, most cost-effective and chemical-free way of dealing with food safety management. An additional benefit of ozone is that it extends the shelf life of food products.

Ozone is applied in the food processing industry through the use of water that has been impregnated with ozone. This ozonated water disinfects the area being sprayed.

Human exposure to ozone, however, can cause permanent respiratory damage even at low levels over prolonged periods of time. To protect employees, ozone levels in the work environment must be monitored. Typically, levels of ozone are measured through the use of fixed monitors located throughout a food processing plant. These monitors are expensive and cannot provide monitoring of every area within a facility. In other words, they can only measure ozone levels within limited areas of a facility leaving some areas, commonly referred to as hot spots, without monitoring coverage.

Passive samplers monitoring gas concentrations are also known in the industry. By definition, a passive sampler is a chemically treated filter paper that changes color when exposed to ozone or other specified gases depending on the chemical formulation or treatment of the filter paper. The color change of the filter paper is then measured by comparison of the exposed filter paper to colormetric charts or strips to determine the level of ozone or other specified gas exposure.

A problem arises with passive samplers, however, in that many environments where passive samplers would be useful, for example, but not limited to, food processing plants, are saturated with water and water vapor with the result that passive samplers themselves become saturated with moisture within a short time. The moisture renders both the filter paper and the chemicals thereon unusable for detecting the desired gas concentrations. The above-described problems are encountered in many industries in situations requiring monitoring of human exposure to various gases in the local environment.

What is needed is a holder for the passive sampler that protects the passive sampler from becoming saturated with moisture and at the same time allows ambient air to permeate the holder allowing the chemical treatment of the passive sampler to react to concentrations of gases to be detected.

### SUMMARY OF THE INVENTION

Illustrative, non-limiting embodiments of the present invention overcome the above disadvantages and other disadvantages not described above. It will be appreciated, of course, that overcoming the general problems mentioned is not a requirement and that various implementations will fall within the scope and spirit of the invention regardless.

A moisture-proof, gas-permeable holder for passive samplers that prevents moisture from interfering with the monitoring capability of the passive sampler while allowing ambient air to reach the passive sampler so that concentrations of gases to be monitored can be detected by the passive sampler is provided.

An aspect of the present invention provides a gas-permeable holder with multiple compartments to accommodate more than one passive sampler.

Another aspect of the present invention provides a method of monitoring a user's exposure to specific gases to be detected using a passive sampler and a holder for the passive sampler.

Additional aspects and advantages of the invention will be set forth in part in the description that follows or may be learned by practice of the invention. The aspects and advantages of the invention may be realized and attained by means of the instrumentalities and combinations particularly pointed out in the appended claims.

### BRIEF DESCRIPTION OF THE DRAWINGS

The above and other features and advantages of the present invention will become more apparent by describing in detail exemplary embodiments thereof. The accompanying drawings, which are incorporated in and constitute a part of this specification, illustrate exemplary embodiments of the invention and, together with the description, serve to explain the aspects, advantages and principles of the invention. In the drawings:

FIG. 1 is an exploded view illustrating a moisture-proof, gas-permeable holder and passive samplers according to a non-limiting exemplary embodiment of the present invention;

FIG. 2 is a perspective view illustrating the moisture-proof, gas-permeable holder according to a non-limiting exemplary embodiment of the present invention with the side swing door in a closed position;

FIG. 3 is a perspective view illustrating the moisture-proof, gas-permeable holder according to a non-limiting exemplary embodiment of the present invention with the side swing door in an open position;

FIGS. 4a and 4b are views illustrating a housing base of the moisture-proof, gas-permeable holder according to a non-limiting exemplary embodiment of the present invention;

FIG. 5 is a view illustrating a slide blocker of the moisture-proof, gas-permeable holder according to a non-limiting exemplary embodiment of the present invention;

FIG. 6 is a view illustrating a membrane of the moisture-proof, gas-permeable holder according to a non-limiting exemplary embodiment of the present invention;

FIGS. 7a and 7b are views view illustrating a housing top cover of the moisture-proof, gas-permeable holder according to a non-limiting exemplary embodiment of the present invention;

FIG. 8 is a cross-sectional view of illustrating a side swing door of the moisture-proof, gas-permeable holder according to a non-limiting exemplary embodiment of the present invention; and

FIG. 9 is a view illustrating a passive sampler for use with the moisture-proof, gas-permeable holder according to a non-limiting exemplary embodiment of the present invention.

While the drawings may set forth dimensions, one of ordinary skill in the art will recognize that these dimensions are exemplary and the embodiments of the invention are not limited by the dimensions indicated on the drawings.

### DETAILED DESCRIPTION OF THE EXEMPLARY EMBODIMENTS

A moisture-proof, gas-permeable holder for passive samplers and a method of monitoring a user's exposure to gases to be detected using a passive sampler and a moisture-proof, gas-permeable holder for the passive sampler will now be described more fully with reference to the accompanying drawings, in which illustrative, non-limiting embodiments of the invention are shown. Also, it will be appreciated that various details are omitted from the drawings so as to avoid obscuring the main points.

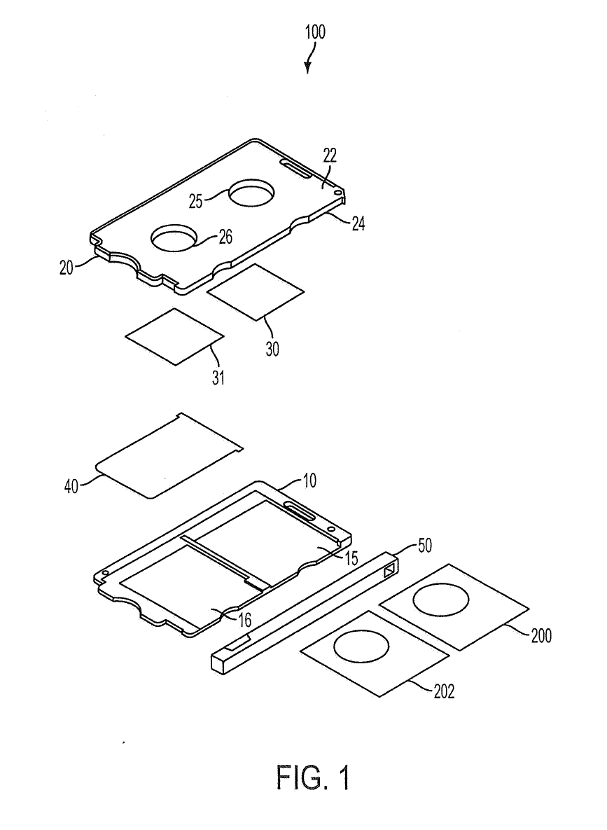

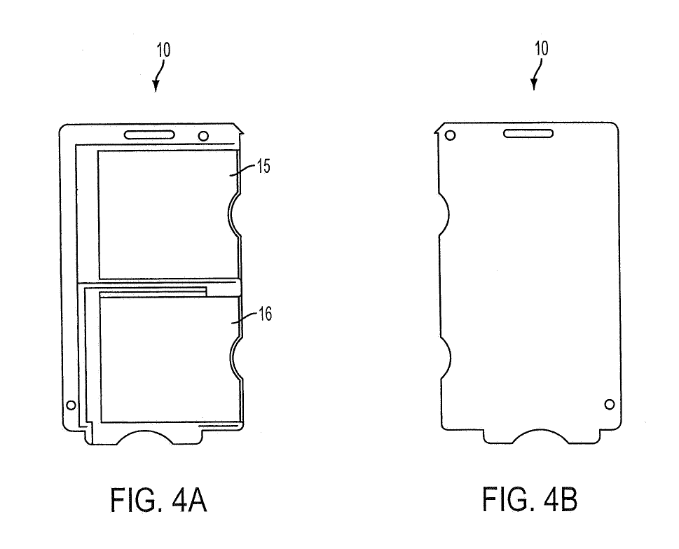

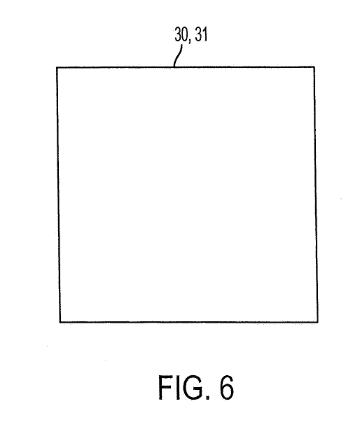

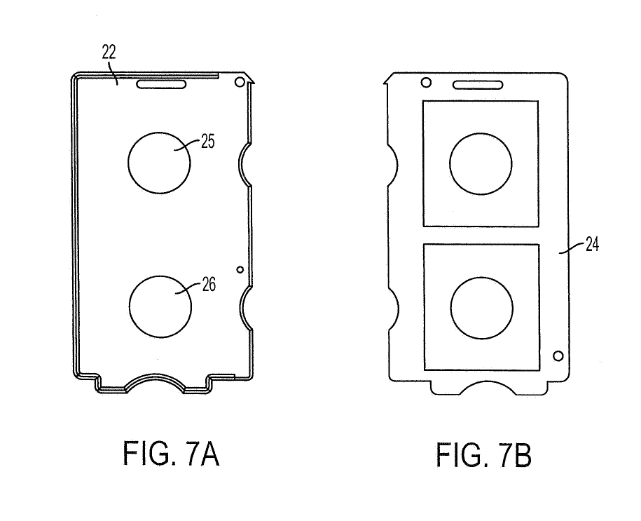

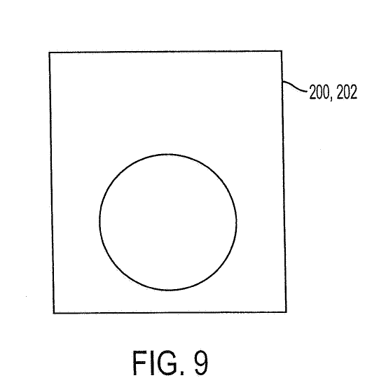

FIG. 1 is an exploded view illustrating the moisture-proof, gas-permeable holder 100 and passive samplers 200, 202 according to a non-limiting exemplary embodiment of the present invention. As illustrated in FIG. 1, the moisture-proof, gas-permeable holder 100 has a housing base 10 (see FIGS. 4a and 4b) having at least one compartment 16 for receiving at least one passive sampler 202 (see FIG. 9). A housing top cover 20 (see FIGS. 7a and 7b) having a first outer surface 22 and a first inner surface 24 forms at least one through-hole 26 and retains at least one moisture-proof, gas-permeable membrane 31 (see FIG. 6) positioned on the inner surface 24 of the housing top cover 20 over the at least one through hole 26. The housing top cover 20 is positioned over the housing base 10 such that the at least one membrane 31 and the at least one through hole 26 are positioned over the at least one compartment 16 for receiving the at least one passive sampler 202. The housing base 10 and the housing top cover 20 are constructed from moisture-proof materials, for example, but not limited to, plastic materials such as Acrylonitrile Butadiene Styrene (ABS) plastic, and light weight metal materials such as aluminum.

In a non-limiting exemplary embodiment illustrated in FIG. 1, two passive samplers 200, 202 can be inserted in the moisture-proof, gas-permeable holder 100, one in an upper compartment 15 and one in a lower compartment 16. Each of the passive samplers 200, 202 can be exposed to ambient air through the membranes 30, 31 disposed over the through-holes 25, 26 while being protected from moisture by the moisture-proof, gas-permeable characteristics of the membranes 30, 31 and the moisture-proof characteristics of the assembled holder.

The moisture-proof, gas-permeable membrane 30 may be constructed as a laminate of polytetrafluoroethylene (PTFE) and polyester and/or polyethylene film. The PTFE may be expanded PTFE, for example, but not limited to, 235ePes or 235eP. The polyester may be, for example, but not limited to, woven polyester or non-woven polyester. The polyethylene film may be for example, but not limited to, ultra high molecular weight polyethlene (UHMW-PE) film. The moisture-proof, gas-permeable membrane 30 may have a thickness in the range of 0.005 inches to 0.013 inches. The pore size of the laminate may be in the range of 0.2-2.0 microns, depending on the materials used to construct the membrane 30.

For example, in a non-limiting exemplary embodiment, the moisture-proof, gas-permeable membrane 30 may be a laminate of 235ePes expanded PTFE (ePTFE) and non-woven polyester, the laminate having a thickness in the range of 0.009-0.013 inches and a pore size in the range of 0.2-2.0 microns with a mean pore size of 0.8 microns. In another non-limiting exemplary embodiment, the moisture-proof, gas-permeable membrane 30 may be a laminate of 235eP porous expanded PTFE (ePTFE) and porous UHMW-PE film, the laminate having a thickness in the range of 0.005-0.007 inches and a pore size in the range of 0.2-1.0 microns with a mean pore size of 0.5 microns. One of ordinary skill in the art will recognize that other laminate combinations with similar materials are possible.

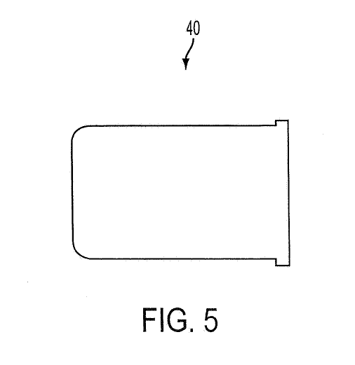

A slide blocker 40 (see FIG. 5) is slideably attached between the housing base 10 and the housing top cover 20 such that when a passive sampler 202 is positioned in the at least one compartment 16 for receiving the passive sampler 202, the slide blocker 40 may be positioned to prevent or to allow ambient air to permeate through the at least one membrane 31 disposed over the through-hole 26 and reach the passive sampler 202.

The slide blocker 40 is constructed from moisture-proof materials, for example, but not limited to, polyester, or plastic materials such as ABS plastic, or light weight metal materials such as aluminum. The slide blocker 40 is designed to stay in place until moved by the user.

In a non-limiting exemplary embodiment of the invention, an upper compartment 15 of the holder may contain a passive sampler 200 capable of sampling a specific gas for eight hours and a lower compartment 16 may contain a passive sampler 202 capable of sampling a specific gas for one hour. In this case, a user may start a first test, for example an eight hour test, at a first time by moving the slide blocker 40 to expose only the passive sampler 200 in the upper compartment 15 to ambient air through the membrane 30 and the through-hole 25 in the upper compartment. The user may start a second test, for example, a one hour test, at the same time or at a second time by moving the slide blocker 40 to additionally expose the passive sampler 202 in the lower compartment 16 to ambient air through the membrane 31 and the through-hole 26 in the lower compartment.

At the end of the second test period, the user may move the slide blocker 40 back to the position blocking further exposure of the passive sampler 202 in the lower compartment 16 to the ambient air.

A side swing door 50 is pivotably attached at an edge of an assembly formed by the housing base 10 and the housing top cover 20 such that the side swing door 50 can be opened to insert and remove the at least one passive sampler 200 in the at least one compartment 15. The side swing door 50 is constructed from moisture-proof materials, for example, but not limited to, plastic materials such as ABS plastic, or light weight metal materials such as aluminum.

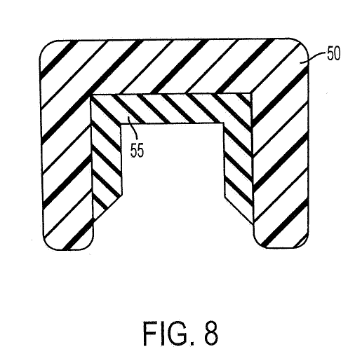

As illustrated in FIG. 8, a moisture seal 55 is disposed on at least one inner surface of the side swing door 50 to prevent moisture from entering the at least one compartment 16. The moisture seal 55 may be constructed from moisture-proof materials, for example, but not limited to, expanded PTFE or rubber.

In a non-limiting exemplary embodiment of the invention, an upper compartment 15 of the holder 100 may contain a first passive sampler 200 and a lower compartment 16 may contain a second passive sampler 202. In this case, the side swing door 50 can be opened to insert and remove the first and second passive samplers 200, 202 in the upper and lower compartments 15, 16, respectively, and the moisture seal 55 disposed on at least one inner surface of the side swing door 50 prevents moisture from entering the upper and lower compartments 15, 16.

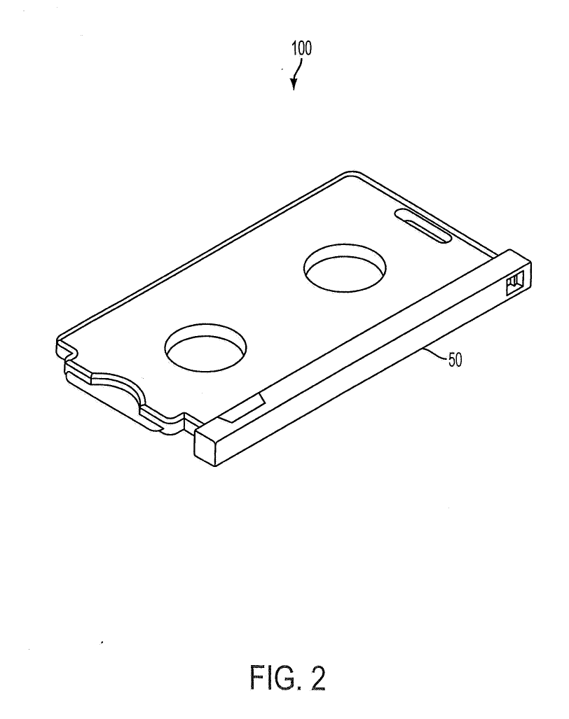

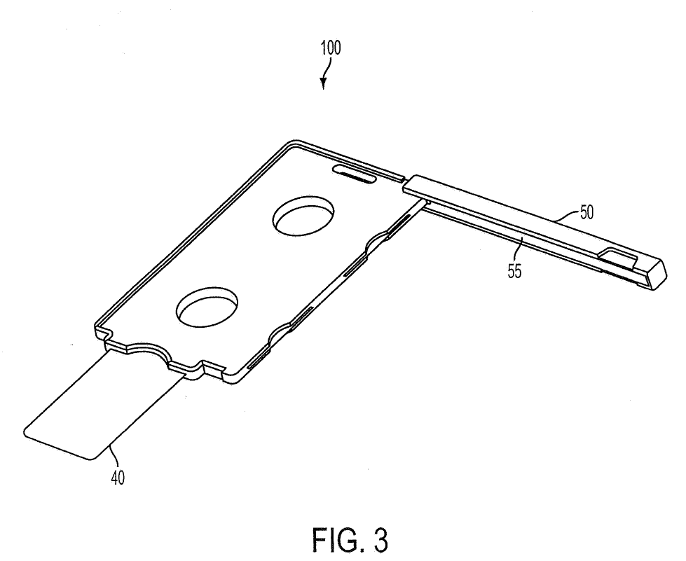

FIG. 2 illustrates a non-limiting exemplary embodiment of the assembled moisture-proof, gas-permeable holder 100 with the side swing door 50 closed and the slide blocker 40 retracted in a position which would expose a passive sampler only in the upper compartment. FIG. 3 illustrates the same non-limiting exemplary embodiment of the assembled moisture-proof, gas-permeable holder 100 with the slide blocker 40 extended in a position which would additionally expose a passive sampler in the lower compartment, and the side swing door 50 opened showing the location of the moisture seal 55.

In another non-limiting exemplary embodiment of the present invention, the housing base and the housing top cover may be assembled to each other with at least one passive sampler pre-installed in at least one compartment. The pre-installed at least one passive sampler is non-removable. Therefore, the side swing door is not provided and the assembled housing base and housing top cover form a moisture-proof seal around the pre-installed at least one passive sampler. In this exemplary embodiment, an adhesive panel may be affixed over the at least one through hole to protect and prevent contamination of the at least one passive sampler.

The at least one passive sampler 200 may be chemically treated to detect various gases, for example, but not limited to, ozone, wherein each passive sampler 200 detects one gas. Each passive sampler 200 may have a set monitoring duration, for example, but not limited to, one-hour monitoring time and eight-hour monitoring time. Passive samplers of different monitoring durations and/or for monitoring different gasses may be inserted into the same moisture-proof, gas-permeable holder 100.

The moisture-proof, gas-permeable holder 100 can be worn by a user outside the clothing to provide monitoring of the selected gas anywhere the user may be located.

Non-limiting exemplary embodiments of the present invention also provide a method of monitoring a user's exposure to specific gases to be detected using a passive sampler and a holder for the passive sampler.

To monitor the level of a user's exposure to a specific gas in a local environment with a non-limiting exemplary embodiment of the invention, a user performs the operations of opening the side swing door 50, inserting one passive sampler 200 in an upper compartment 15 and inserting another passive sampler 202 in a lower compartment 16 of the moisture-proof, gas-permeable holder 100, closing the side swing door 50, moving the slide blocker 40 to expose only the passive sampler 200 in the upper compartment to ambient air, and wearing the gas-permeable holder 100 on the outside of the user's clothing. The user may start an additional test by moving the slide blocker 40 to additionally expose the passive sampler 202 in the lower compartment 16 to ambient air. After a time period determined by the characteristics of the passive samplers 202 in the lower compartment 16, the user performs the operation of moving the slide blocker 40 back to the position blocking further exposure of the passive sampler 202 in the lower compartment 16 to the ambient air.

To determine the level of exposure to a specific gas detected by the passive samplers 200, 202 the user performs the operations of opening the side swing door 50, extracting the passive samplers 200, 202 from the upper and lower compartments 15, 16 of the moisture-proof, gas-permeable holder 100, and comparing the exposed passive samplers 200, 202 to colormetric charts or strips, or otherwise determining the relative color of the exposed passive samplers 200, 202 thereby determining the level of exposure to the specified gas.

In another non-limiting exemplary embodiment of the invention, the passive samplers are non-removable from the moisture-proof, gas-permeable holder. To monitor the level of a user's exposure to a specific gas in a local environment with this exemplary embodiment, a user need only perform the operation of wearing the moisture-proof, gas-permeable holder on the outside of the user's clothing, thereby exposing a passive sampler in an upper compartment to ambient air. The user may start an additional test by moving a slide blocker to additionally expose a passive sampler in a lower compartment to ambient air. After a time period determined by the characteristics of the passive sampler in the lower compartment, the user performs the operation of moving the slide blocker back to the position blocking further exposure of the passive sampler in the lower compartment to the ambient air.

To determine the level of exposure to a specific gas detected by the passive samplers the user performs the operation of comparing the exposed passive samplers retained in the holder to colormetric charts or strips, or otherwise determining the relative color of the exposed passive samplers thereby determining the level of exposure to the specified gas.

The foregoing description of the exemplary embodiments of the invention has been presented for purposes of illustration and description. It is not intended to be exhaustive or to limit the invention to the precise form disclosed, and modifications and variations are possible in light of the above teachings or may be acquired from practice of the invention. The exemplary embodiments were chosen and described in order to explain the principles of the invention and its practical application to enable one skilled in the art to utilize the invention in various exemplary embodiments and with various modifications as are suited to the particular use contemplated.

Thus, while only certain exemplary embodiments of the invention have been specifically described herein, it will be apparent that numerous modifications may be made thereto without departing from the spirit and scope of the invention. Further, acronyms are used merely to enhance the readability of the specification and claims. It should be noted that these acronyms are not intended to lessen the generality of the terms used and they should not be construed to restrict the scope of the claims to the exemplary embodiments described therein.

What is claimed is:

1. A holder for retaining a passive sampler, the holder comprising:
a moisture-proof housing forming at least one hole in a first surface; and
a moisture-proof, gas-permeable membrane disposed over the at least one hole,
wherein the moisture-proof housing comprises at least one compartment, exposed to ambient air through the moisture-proof, gas-permeable membrane, which accepts a passive sampler.

2. The holder as claimed in claim 1, further comprising a slide blocker slideably attached to the moisture-proof housing and disposed between the moisture-proof, gas-permeable membrane in the at least one compartment, wherein the slide blocker is extended from the moisture-proof housing to expose the at least one compartment to ambient air entering through the moisture-proof, gas-permeable membrane, and wherein the slide blocker is retracted into the moisture-proof housing to prevent ambient air from entering the at least one compartment through the moisture-proof, gas-permeable membrane.

3. The holder as claimed in claim 1, further comprising:
a side-swing door; and
a moisture-proof seal disposed on at least one inner surface of the side-swing door,
wherein the moisture-proof seal prevents moisture from entering the at least one compartment when the side-swing door is in a closed position.

4. The holder as claimed in claim 1, wherein the passive sampler samples ozone.

5. The holder as claimed in claim 1, wherein the moisture-proof, gas-permeable membrane is constructed as a laminate of PTFE and polyester film.

6. The holder as claimed in claim 1, wherein the moisture-proof, gas-permeable membrane is constructed as a laminate of PTFE and polyethylene film.

7. The holder as claimed in claim 1, wherein the moisture-proof, gas-permeable membrane is it as a laminate of PTFE, polyester film and polyethylene film.

8. The holder as claimed in claim 8, wherein the PTFE is one of 235ePES and 235eP.

9. A passive sampler holder, comprising:
a housing top cover forming at least one hole;
a housing base attached to the housing top cover forming a compartment between the housing top cover and the housing base;
a moisture-proof, gas-permeable membrane disposed over the at least one hole;
a slide blocker slideably attached within the moisture-proof housing; and
a side-swing door comprising a moisture-proof seal disposed on at least one inner surface.

10. The passive sampler holder as claimed in claim 9, wherein:
the housing top cover forms two holes;
the housing base, when attached to the housing top cover, forms two compartments between the housing top cover and the housing base;
a moisture-proof, gas-permeable membrane is disposed over each hole;
the slide blocker extends from the housing to expose one of the two compartments to ambient air entering through the moisture-proof, gas-permeable membrane, and the slide blocker retracts into the housing to prevent ambient air from entering the one of the two compartments through the moisture-proof, gas-permeable membrane.

11. The passive sampler holder as claimed in claim 9, wherein the housing top cover, the housing base and the slide blocker are constructed from plastic.

12. The passive sampler holder as claimed in claim 9, wherein the housing top cover, the housing base and the slide blocker are constructed from aluminum.

13. The passive sampler holder as claimed in claim 9, wherein the moisture-proof, gas-permeable membrane is it as a laminate of PTFE, polyester film and polyethylene film.

14. A method of monitoring a user's exposure to a gas in ambient air using a passive sampler holder, the method comprising:
opening an access door of the passive sampler holder to access at least one internal compartment configured to accept a passive sampler;
inserting a passive sampler into at least one of the internal compartments;
closing the access door;
attaching the passive sampler holder to the user; and
extending a slide blocker from the passive sampler holder to expose one of the internal compartments to ambient air, or retracting the slide blocker into the passive sampler holder to prevent ambient air from entering the one of the internal compartments.

15. The method as claimed in claim 14, wherein the passive sampler samples ozone.
